(19) United States
(12) Patent Application Publication
(10) Pub. No.: US 2010/0010970 A1
(43) Pub. Date: Jan. 14, 2010

(54) DOCUMENT SEARCHING DEVICE, DOCUMENT SEARCHING METHOD, DOCUMENT SEARCHING PROGRAM

(75) Inventors: Jun Takeuchi, Tokushima-shi (JP); Takanori Hino, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 12/443,089

(22) PCT Filed: Sep. 28, 2007
(86) PCT No.: PCT/JP2007/001066

§ 371 Date: Mar. 26, 2009

(30) Foreign Application Priority Data
Sep. 29, 2006 (JP) 2006-267889

(51) Int. Cl. G06F 7/10; G06F 17/30

(52) U.S. Cl. 707/3; 707/E17.008; 707/E17.014

(57) ABSTRACT

A document retrieval apparatus holds: index information in which data and an entity document are associated, with respect to a group of entity documents that are XML documents including entity information; and index information in which data and an annotation document are associated, with respect to a group of annotation documents including annotation information that corresponds to the entity information, respectively. Upon receiving an input of a retrieval query including the entity data for retrieval and the annotation data for retrieval, the document retrieval apparatus at first specifies an entity document including the entity data for retrieval. Further, the document retrieval apparatus specifies an annotation document including the annotation data for retrieval, and specifies an entity document corresponding to the specified annotation document. Subsequently, the document retrieval apparatus selects an entity document that meets the retrieval query from the entity document specified by the entity data for retrieval and the entity document specified by the annotation data for retrieval.

### FIELD OF THE INVENTION

The present invention relates to a document processing technique, in particular, to an information retrieval technique in which a structured document file is handled.

### BACKGROUND ART

With the growing use of computers and the progress of the networking techniques, there has been an increase in electronic information exchange via network. In this background, a lot of paperwork that is conventionally paper-based has been replaced by network-based processing. The progress of the digitization and the networking technique has dramatically lowered the cost for information acquisition. Under these circumstances, there is an increasing importance of the technique in which desired data is retrieved from a lot of document files.

Patent Document 1: Japanese Patent Laid-Open No. 2006-048536

Patent Document 2: Japanese Patent Laid-Open No. 2004-206658

### DISCLOSURE OF THE INVENTION

### Problem to be Solved by the Invention

A person who is reading a paper document not only reads the document but also often writes annotations such as opinions, complements, and comments in the document. If electronic documents can be provided with annotations by persons reading it, convenience of the electronic documents can be further improved. The Patent Document 2 stated above discloses an example of a technique for providing annotations to such electronic information. The present inventor has paid attention to annotations provided to document files, and has envisaged that document file retrievals can be implemented more efficiently by using the annotations.

The present invention has been made based on the above idea, and a general purpose thereof is to provide a technique for retrieving a desired document file efficiently from a plurality of document files by using annotation information.

### Means for Solving the Problem

An embodiment of the present invention relates to a document retrieval apparatus for retrieving a desired structured document file from a group of structured document files described in XML (extensible Markup Language) and XHTML (extensible HyperText Markup Language) or the like. The apparatus holds entity index information for specifying an entity document including certain data, with respect to a group of entity documents including entity information; and annotation index information for specifying an annotation document including certain data, with respect to a group of annotation documents including annotation information corresponding to the entity information, respectively. The apparatus receives an input of a retrieval query and specifies an entity document including entity data for retrieval that is designated in the retrieval query. The apparatus similarly specifies an annotation document including annotation data for retrieval that is designated in the retrieval query, and specifies an entity document corresponding to the specified annotation document. Subsequently, the apparatus selects an entity document that meets the retrieval query from the entity document specified by the entity data for retrieval, and from the entity document specified by the annotation data for retrieval.

Herein, the “entity information” means the data to be a content to be retrieved, and examples of which include, for example, an element, a tag, and an attribute or the like. The “entity document” means a structured document file storing the entity information. The “annotation information” means the data indicating an annotation provided by a user, and example of which include, for example, an element, a tag, and an attribute or the like. The “annotation document” means a structured document file storing the annotation information. The entity information and the annotation information are stored separately in different documents that are referred to as an entity document and an annotation document, respectively, and relations between data and documents are indexed with respect to each of the entity document and the annotation document. With the use of the two types of the index information, a desired entity document can be retrieved from both sides of the entity information and the annotation information.

It is noted that any combination of the aforementioned components or any manifestation of the present invention realized by modification of a method, system, program, and recording medium and so forth, is effective as an embodiment of the present invention.

### Advantage of the Invention

According to the present invention, a desired document file can be efficiently retrieved from a plurality of document files by using the annotation information.

### BRIEF DESCRIPTION OF THE DRAWINGS

FIG. 1 is a schematic diagram illustrating an outline of the processing by the document retrieval apparatus;

FIG. 2 is a diagram illustrating an entity document with a document ID of 1, and an annotation document corresponding to the entity document, in the present embodiment;

FIG. 3 is a diagram illustrating an entity document with a document ID of 2, and an annotation document corresponding to the entity document, in the present embodiment;

FIG. 4 is a diagram illustrating a data structure of entity path index information;

FIG. 5 is a diagram illustrating a data structure of entity character string index information;

FIG. 6 is a diagram illustrating a data structure of annotation path index information;

FIG. 7 is a diagram illustrating a data structure of annotation character string index information;

FIG. 8 is a diagram illustrating functional blocks of the document retrieval apparatus; and

FIG. 9 is a flow chart illustrating a process of retrieval processing based on a retrieval query.

### REFERENCE NUMERALS

100 DOCUMENT RETRIEVAL APPARATUS

110 USER INTERFACE PROCESSOR

112 INPUT UNIT

114 DISPLAY UNIT

120 DATA PROCESSOR

122 ENTITY RETRIEVAL UNIT

124 ANNOTATION RETRIEVAL UNIT

126 FIRST ENTITY DOCUMENT SPECIFICATION UNIT

128 ANNOTATION DOCUMENT SPECIFICATION UNIT

130 SECOND ENTITY DOCUMENT SPECIFICATION UNIT

132 ENTITY DOCUMENT SELECTION UNIT

134 REGISTRATION UNIT

140 ENTITY INDEX HOLDER

142 ANNOTATION INDEX HOLDER

144 ENTITY DOCUMENT DATA BASE

146 ANNOTATION DOCUMENT DATA BASE

148 DOCUMENT POSITION COLUMN

150 ENTITY PATH INDEX INFORMATION

152 ENTITY PATH EXPRESSION COLUMN

154 ENTITY RANGE COLUMN

160 ENTITY CHARACTER STRING INDEX INFORMATION

162 ENTITY CHARACTER STRING COLUMN

164 ENTITY POSITION INDEX COLUMN

170 ANNOTATION PATH INDEX INFORMATION

172 ANNOTATION PATH EXPRESSION COLUMN

174 ANNOTATION RANGE COLUMN

180 ANNOTATION CHARACTER STRING INDEX INFORMATION

182 ANNOTATION CHARACTER STRING COLUMN

184 ANNOTATION POSITION INDEX COLUMN

### BEST MODE FOR CARRYING OUT THE INVENTION

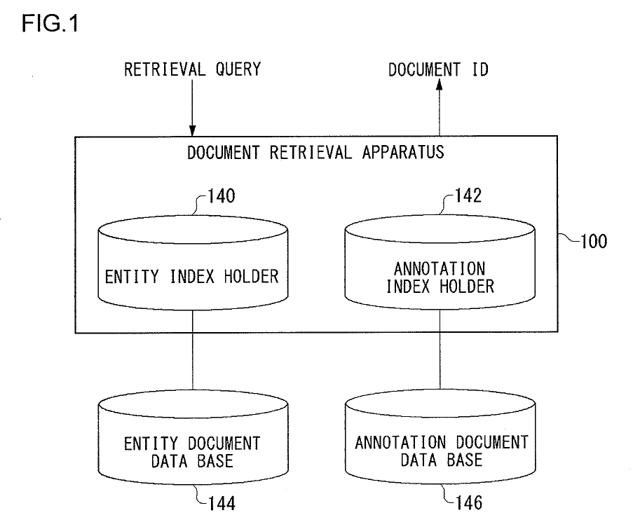

FIG. 1 is a schematic diagram illustrating an outline of the processing by the document retrieval apparatus 100. The entity document data base 144 stores an entity document to be retrieved. The entity document is a structured document file structured by a tag. In the present embodiment, a description will be made on the premise that an entity document is an XML file. The annotation document data base 146 stores an annotation document. A description will be made on the premise that an annotation document is also a structured document file and similarly an XML file.

An entity document includes a content to be retrieved as entity information. In the present embodiment, a description will be made on the premise that all information included in an entity document fall under the category of the “entity information”. On the other hand, an annotation document is associated with an entity document and includes annotation information corresponding to the entity information in the corresponding entity document. In the present embodiment, a description will be made on the premise that all information included in an annotation document fall under the category of the “annotation information”. An entity document and an annotation document are associated in a one-to-one correspondence.

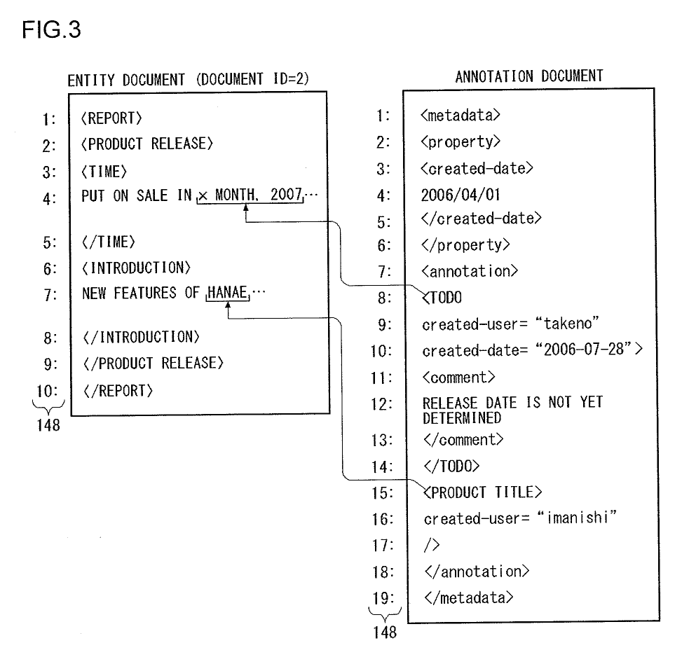

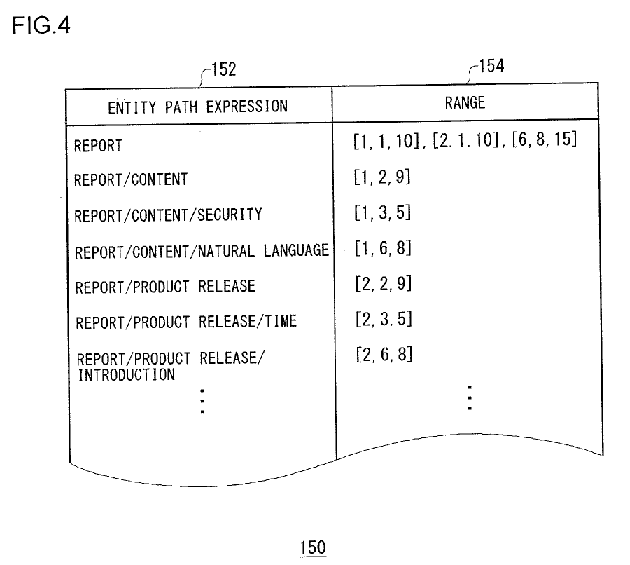

A user can provide annotation information to an entity document. Specifically, when an entity document to which a user desires an annotation to be provided is screen displayed, the user inputs a range and a position of the entity document to be annotated, and a content of the annotation. The data thus inputted is stored in the annotation document associated with the entity document. Such system can be implemented by a known XML-related technique such as XLink (XML Linking Language). The relation between an entity document and an annotation document will be described in detail with reference to FIGS. 3 and 4.

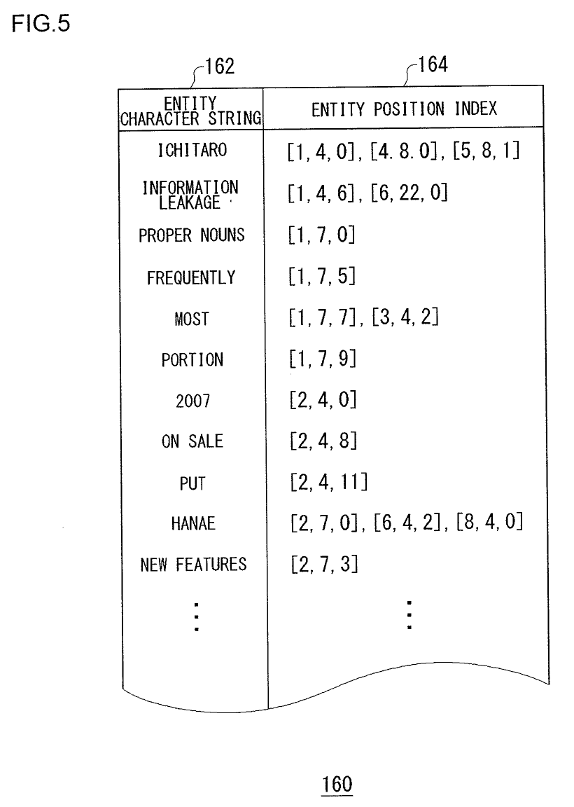

In the entity index holder 140 of the document retrieval apparatus 100, index information with respect to a group of the entity documents in the entity document data base 144, is stored. There are two types of index information stored in the entity index holder 140, entity path index information 150 and entity character string index information 160, each of which will be described in detail later with reference to FIGS. 4 and 5.

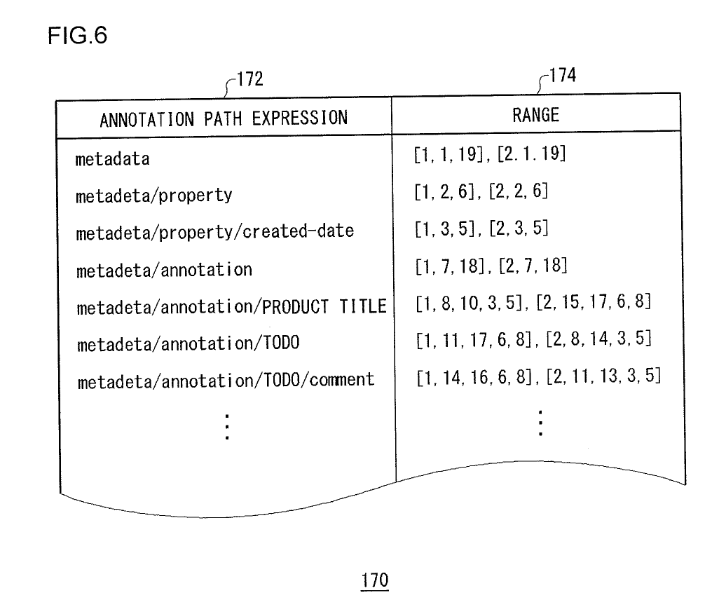

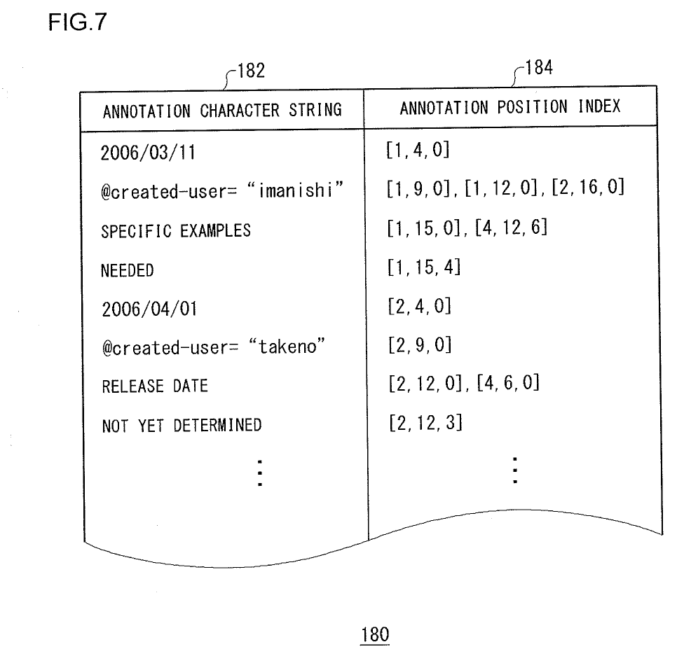

In the annotation index holder 142 of the document retrieval apparatus 100, index information with respect to the annotation documents in the annotation document data base 146, is stored. There are two types of the index information stored in the annotation index holder 142, annotation path index information 170 and annotation character string index information 180, each of which will be described in detail later with reference with FIGS. 6 and 7.

The document retrieval apparatus 100 executes document retrieval processing with respect to a group of entity documents stored in the entity document data base 144 and a group of annotation documents stored in the annotation document data base 146, based on the above four-type index information. In retrieving a document, a user inputs a retrieval query into the document retrieval apparatus 100. In the retrieval query, a path expression and a character string that are to be present in an entity document, or an path expression and a character string that are to be present in an annotation document that is associated with the entity document to be retrieved, are included. The document retrieval apparatus 100 retrieves an entity document that meets a retrieval query based on the inputted retrieval query and the various index information. Upon completing the retrieval processing, the document retrieval apparatus 100 screen displays a document ID of the detected document file. Hereinafter, an entity document and an annotation document will be at first described, followed by a detail description with respect to the various index information stored in the entity index holder 140 and the annotation index holder 142, and subsequently, specific functions of the document retrieval apparatus 100 will be described.

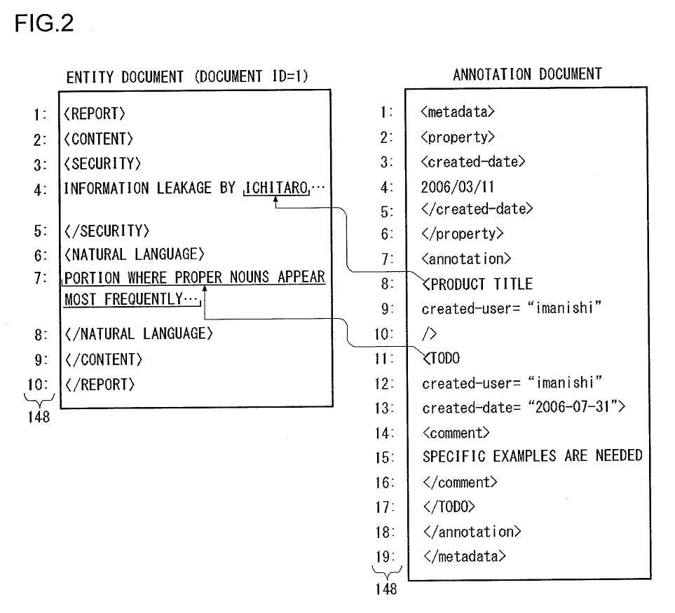

FIG. 2 is a diagram illustrating an entity document with a document ID=1, and an annotation document corresponding to the entity document, in the present embodiment. Each entity document is provided with a document ID. The document ID is used for specifying an entity document uniquely in the entity document data base 144. An XML file illustrated in left part of the drawing is an entity document with a document ID=1, and an XML file illustrated in right part thereof is an annotation document to be associated with the entity document. In the present embodiment, an entity document and an annotation document is associated in one-to-one correspondence; hence, the document ID can be said that it specifies uniquely not only an entity document but also an annotation document that is to be associated with the entity document. Hereinafter, an entity document with a document ID=n (n: natural number) is denoted with an “entity document (ID: n)”, and an annotation document associated with the entity document (ID: n) is denoted with an “annotation document (ID: n)”

The entity document (ID: 1) is a report regarding an imaginary product “Ichitaro”, which is structured by a plurality of tags such as <report>, <content>, and <security>. The document position column 148 of the entity document (ID: 1) indicates positions of various entity information included in the entity document (ID: 1). For example, a document position of the tag <report> in the entity document (ID: 1) is “1”, and that of the tag </security> is “5”. In addition, a document position of the character string “Ichitaro”, which is the element data of the tag <security>, is “4”. Document positions are assigned to every various data in an XML format such as tag, attribute, comment, and element of a tag, and has a unique number in a document.

The annotation document (ID: 1) is to be associated with the entity document (ID: 1), and includes annotation information corresponding to entity information included in the entity document (ID: 1). The annotation document (ID: 1) is also structured by a lot of tags such as <metadata>, <annotation>, and <product title>. The document position column 148 of the annotation document (ID: 1) indicates positions of various annotation information included in the annotation document (ID: 1). Of the annotation information included in the annotation document (ID: 1), the tag <product title> is associated with the character string “Ichitaro” that is present at the document position “4” of the entity document (ID: 1) by an XLink (not illustrated). This indicates that the element data of the tag <product title> is annotation information with respect to the entity information “Ichitaro”. Similarly, the tag <TODO> is associated with the character string “a portion where proper nouns appear frequently” that is present at the document position “7” of the entity document (ID: 1).

FIG. 3 is a diagram illustrating an entity document with a document ID=2, and an annotation document corresponding to the entity document, in the present embodiment. An XML file illustrated in left part of the drawing is an entity document (ID: 2), and an XML file illustrated in right part thereof is an annotation document (ID: 2) that is to be associated with the entity document (ID: 2 ). The entity document (ID: 2) is a report regarding an imaginary product “Hanae”, which is structured by a plurality of tags such as <report>, <product release>, and <introduction>. The annotation document (ID: 2) is also structured by a lot of tags such as <metadata>, <annotation>, and <product title>. Of the annotation information included in the annotation document (ID: 2), the tag <TODO> is to annotate the character string “X month, 2007” that is present at the document position “4” of the entity document (ID: 2). Similarly, the tag <product title> is to annotate the character string “Hanae” that is present at the document position “7” of the entity document (ID: 2). In this way, an entity document and an annotation document that are associated in one-to-one correspondence, are stored in the entity document data base 144 and the annotation document data base 146, respectively. Subsequently, a data structure of each index information of the entity path index information 150, the entity character string index information 160, the annotation path index information 170, and the annotation character string index information 180, will be described based on the entity document (ID: 1) and the annotation document (ID: 1) illustrated in FIG. 2, and the entity document (ID: 2) and the annotation document (ID: 2) illustrated in FIG. 3.

FIG. 4 is a diagram illustrating a data structure of the entity path index information 150. The entity path index information 150 is stored in the entity index holder 140. The entity path expression column 152 illustrates a synopsis of path expressions that are present in any one of the entity documents included in the entity document data base 144. A path expression means a syntax for specifying a data position in a structured document file based on a hierarchical structure of tags such as “/report/content/security”. Hereinafter, when differentiating a path expression in an entity document from that in an annotation document, the former is referred to as an “entity path expression”, and the latter as an “annotation path expression”.

The entity range column 154 illustrates a data range indicated by an entity path expression in the form of [document ID, starting position, end position]. In the case of the entity document (ID: 1), because the document position of the tag <natural language> is “6”, and that of the tag </natural language> is “8”, the range of the element data of “/report/content/natural language” is the document position=(6,8) in the entity document (ID: 1). Therefore, the range data illustrated in the entity range column 154 is [1,6,8].

Similarly, the range data of the entity path expression “/report/product release/time” is [2,3,5]. This means that the document position (3,5) in the entity document (ID: 2) is the range of the data specified by the entity path expression. The range data of the path expression “/report” are present in three ranges of [1,1,10], [2,1,10] and [6,8,15]. This means that the entity path expression “/report” is included in three XML documents of the entity document (ID: 1), the entity document (ID: 2), and the entity document (ID: 6).

FIG. 5 is a diagram illustrating a data structure of the entity character string index information 160. The entity character string index information 160 is also stored in the entity index holder 140. The entity character string column 162 illustrates character strings that are to be keys for retrievals in the entity character string index information 160. The character string stated herein is a character string present in any one of the entity documents included in the entity document data base 144. A character string to be a key may be extracted from the entity documents by using a known technique such as a morphologic analysis. The character string may also be extracted from a document by using any extraction rule, or may be extracted by a user's selection. A character string to be targeted is extracted from attribute values, comment data, and element data of tags or the like. Hereinafter, when differentiating a character string to be a key for retrieval in an entity document from that in an annotation document, the former is referred to as an “entity character string”, and the latter as an “annotation character string”.

The entity position index column 164 illustrates positions where character strings are present in the form of [document ID, document position, offset]. Position data having such a form is referred to as a “position index”. Hereinafter, when differentiating a position index in an entity document from that in an annotation document, the former is referred to as an “entity position index” and the latter as an “annotation position index”.

The character string “information leakage” is present from the seventh character at the document position “4” as part of the element data of the tag <security> in the entity document (ID: 1) (Note: the text “information leakage by Ichitaro . . . ” at the document position “4” in FIG. 2 is denoted in Japanese by eleven characters: “ichi (Chinese character)/ta (Chinese character)/rou (Chinese character)/ni (Hiragana)/yo (Hiragana)/ru (Hiragana)/jo (Chinese character)/ho (Chinese character)/rou (Chinese character)/ei (Chinese character)/no (Hiragana)”. Among them, the text “information leakage” is denoted by the “jo (Chinese character)/ho (Chinese character)/rou (Chinese character)/ei (Chinese character)” that are present from the seventh character. Hereinafter, the present embodiment will be described on the premise of being processed in Japanese; however, the present invention is also applicable to the cases of being processed in languages other than Japanese). The offset indicates a character position where a relevant character string is present when the position of the head character in each document position is 0. The character string “information leakage” is present from the seventh character; hence the offset thereof is “6”. Accordingly, the entity position index of the entity character string “information leakage” is [1,4,6]. The entity character string “information leakage” is also included in the entity document (ID: 6). Therefore, the entity character string “information leakage” is associated with a plurality of types of the entity position indexes.

FIG. 6 is a diagram illustrating a data structure of the annotation path index information 170. The annotation path index information 170 is stored in the annotation index holder 142. The annotation path index expression column 172 illustrates a synopsis of annotation path expressions that are present in any one of the annotation documents included in the annotation document data base 146.

The annotation range column 174 illustrates a data range indicated by an annotation path expression in the form of [document ID, starting position, end position]. In the case of the annotation document (ID: 1), because the document position of the tag <annotation> is “7”, and that of the tag </annotation> is “18”, the range of the element data of “/metadata/annotation” is the document position=(7,18) in the annotation document (ID: 1). Accordingly, the range data illustrated in the annotation range column 174 is [1,7,18]. The annotation path expression “/metadata/annotation” is also present in the document position=(7, 18) in the annotation document (ID: 2). Accordingly, the range data [2,7,18] also corresponds to the annotation path expression “/metadata/annotation”.

The annotation position index of the annotation path expression “/metadata/annotation/TODO” has five elements as illustrated in [1,11,17,6,8] and [2,8,14,3,5]. An annotation position index of this type is denoted by the form of [document ID, starting position (in an annotation document), end position (in an annotation document), starting position (in an entity document), end position (in an entity document)]. The fourth and fifth elements indicate the range of the entity information that is to be annotated by the annotation information indicated by the annotation path expression. Hereinafter, the fourth and fifth elements in an annotation position index are, in particular, referred to as “annotation elements”.

In the case of the annotation document (ID: 1) illustrated in FIG. 2, the annotation path expression “/metadata/annotation/TODO” is to annotate “a portion where proper nouns appear frequently” that is element data of the tag <natural language> in the entity document (ID: 1). Because the document position of the tag <natural language> in the entity document (ID: 1) is (6,8), the annotation position index of the annotation path expression “/metadata/annotation/TODO” is [1,11,17,6,8]. Similarly, in the case of the annotation document (ID: 2) illustrated in FIG. 3, the annotation path expression “/metadata/annotation/TODO” is to annotate “X month, 2007” that is element data of the tag <time> in the entity document (ID: 2). Because the document position of the tag <time> in the entity document (ID: 2) is (3,5), the annotation position index is [2,8,14,3,5].

The annotation position indexes of the annotation path expression “/metadata/annotation/TODO/comment” are [1,14,16,6,8] and [2,11,13,3,5]. Annotation elements of an annotation path expression that does not directly designate the entity information as an annotation target as with the annotation path expression “/metadata/annotation/TODO/comment”, are the same as that of an annotation path expression that is a one-level higher annotation path expression “/metadata/annotation/TODO”. When the one-level higher annotation path expression does not have an annotation element, the aforementioned elements are the same as that of the annotation path expression that is further higher. An annotation path expression of which any higher annotation path expression does not have an annotation element, and that does not directly designate annotation information as an annotation target, as with “/metadate/property/created-date”, does not have an annotation element.

FIG. 7 is a diagram illustrating a data structure of the annotation character string index information 180. The annotation character string index information 180 is also stored in the annotation index holder 142. The annotation character string column 182 indicates annotation character strings. The annotation character string is a character string present in any one of the annotation documents included in the annotation document data base 146. The annotation position index column 184 illustrates an annotation position index in the form of [document ID, document position, offset].

The character string “specific examples” is present from the first character at the document position “15” in the annotation document (ID: 1) (Note: the text “specific examples are needed” at the document position “15” in FIG. 2 is denoted in Japanese by seven characters “gu (Chinese character)/tai (Chinese character)/rei (Chinese character)/ga (Hiragana)/ho (Chinese character)/si (Hiragana)/i (Hiragana)”. Among them, the text “specific examples” is denoted by the first three characters “gu (Chinese character) /tai (Chinese character)/rei (Chinese character)”). Accordingly, the offset of the annotation character string “specific examples” is “0”, and the annotation position index is [1,15,0]. The annotation character string “specific examples” is also present in the annotation document (ID: 4), and the annotation position index thereof is [4,12,6]. The annotation character string “imanishi” is present as an attribute value of the attribute “created-user” of tag <product title> and the tag <TODO> of the annotation document (ID: 1), and the tag <product title> of the annotation document (ID: 2). Such a character string present as an attribute value is registered in the form of “@attribute name=“attribute value” in the annotation character string column 182. The same is true also in the entity character string index information 160. The annotation character string “@created-user=”imanishi” is included in the offset “0” at the document position “9” in the annotation document (ID: 1), the offset “0” at the document position “12” in the annotation document (ID: 1), and the offset “0” at the document position “16” in the annotation document (ID: 2). Accordingly, the annotation position indexes of the annotation character string “@created-user=“imanishi”” are [1,9,0], [1,12,0], and [2,16,0].

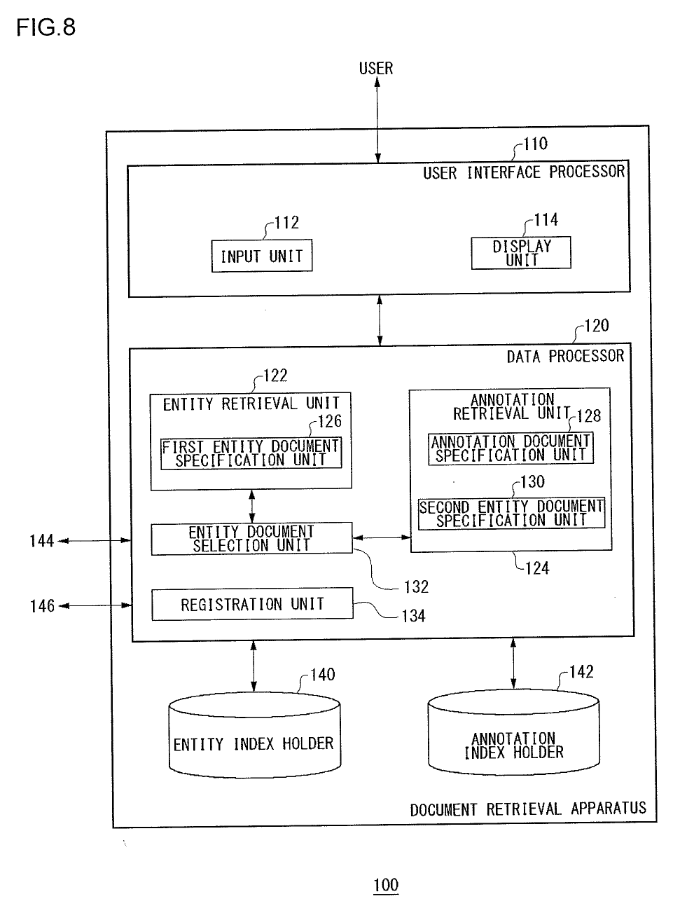

FIG. 8 is a diagram illustrating functional blocks of the document retrieval apparatus 100. Each block illustrated herein is implemented in hardware by any CPU of a computer, other elements, and mechanical devices, and implemented in software by a computer program or the like. FIG. 8 depicts functional blocks implemented by the cooperation of hardware and software. Therefore, it will be obvious to those skilled in the art that these functional blocks may be implemented in a variety of manners by a combination of hardware and software.

The document retrieval apparatus 100 comprises: a user interface processor 110, a data processor 120, an entity index holder 140, and an annotation index holder 142. The user interface processor 110 is in charge of processes with regard to a general user interface such as processing an input from a user and displaying information to the user. In the present embodiment, on the premise that a user interface service of the document retrieval apparatus 100 is provided by the user interface processor 110, a description will be made below. As another embodiment, a user may manipulate the document retrieval apparatus 100 via the Internet. In the case, a communication unit (not illustrated) receives manipulation-instruction information from a user terminal and transmits the information on a processing result executed based on the manipulation-instruction to the user terminal.

The data processor 120 executes various data processing based on the data acquired from the user interface processor 110, the entity index holder 140, the annotation index holder 142, the entity document data base 144, and the annotation document data base 146. The data processor 120 also plays a role of an interface between the user interface processor 110 and the entity index holder 140.

The user interface 110 includes an input unit 112 and the display unit 114. The input unit 112 receives input manipulation from a user. The display unit 114 displays various information to the user. A retrieval query is acquired through the input unit 112. The retrieval query includes both or either of “entity data for retrieval” and/or “annotation data for retrieval”, wherein the “entity data for retrieval” indicates a retrieval condition that is used for an entity document such as an entity path expression and an entity character string, and the “annotation data for retrieval” indicates a retrieval condition that is used for an annotation document such as an annotation path expression and an annotation character string.

The data processor 120 includes an entity retrieval unit 122, an annotation retrieval unit 124, an entity document selection unit 132, and an registration unit 134. The entity retrieval unit 122 retrieves an entity document based on the entity data for retrieval. The entity retrieval unit 122 includes a first entity document specification unit 126. The first entity document specification unit 126 specifies an entity document meeting a retrieval condition indicated by the entity data for retrieval (hereinafter, an entity document thus specified is referred to as a “first entity document”). For example, when the entity path expression “/report” is designated as the entity data for retrieval, the first entity document specification unit 126 specifies the entity document (ID: 1), the entity document (ID: 2), and the entity document (ID: 6) as the first entity documents, with reference to the entity path index information 150. When the entity character string “information leakage” is designated as the entity data for retrieval, the first entity document specification unit 126 specifies the entity document (ID: 1) and the entity document (ID: 6) with reference to the entity character string index information 160. When the entity data for retrieval is “entity path expression=/report and entity character string=information leakage”, the entity document (ID: 1) and the entity document (ID: 6) are specified that meet both the entity path expression and the entity character string, are specified as the first entity documents. In this way, the first entity document specification unit 126 specifies an entity document that meets the entity data for retrieval of a retrieval query, as the first entity document. The processing in which a first entity document is specified by the entity retrieval unit 122 is referred to as “entity retrieval processing”.

The annotation retrieval unit 124 retrieves an entity document based on the annotation data for retrieval. The annotation retrieval unit 124 includes an annotation document specification unit 128 and a second entity document specification unit 130. The annotation document specification unit 128 specifies an annotation document that meets a retrieval condition indicated by the annotation data for retrieval. For, example, when the annotation path expression “/metadata/annotation/product title” is designated as the annotation data for retrieval of the retrieval query, the annotation document specification unit 128 specifies the annotation document (ID: 1) and the annotation document (ID: 2) with reference to the annotation path index information 170. The second entity document specification unit 130 specifies an entity document that is associated with the specified annotation document (hereinafter, an entity document thus specified is referred to as a “second entity document”). When the annotation character string “release date” is designated as the annotation data for retrieval, the annotation document specification unit 128 specifies the annotation document (ID: 2) and the annotation document (ID: 4) with reference to the annotation character string index information 180, and the second entity document specification unit 130 specifies the entity document (ID: 2) and the entity document (ID: 4). When the annotation data for retrieval is “annotation path expression=/metadata/annotation/product title and annotation character string=release date”, only the entity document (ID: 2) is specified as a second entity document that meets a retrieval condition with respect to the annotation path expression and the annotation character string. As stated above, the annotation document specification unit 128 and the second entity document specification unit 130 specify an entity document that meets the annotation data for retrieval of a retrieval query of, as a second entity document. The processing in which a second entity document is specified by the annotation retrieval unit 124 is referred to as “annotation retrieval processing”.

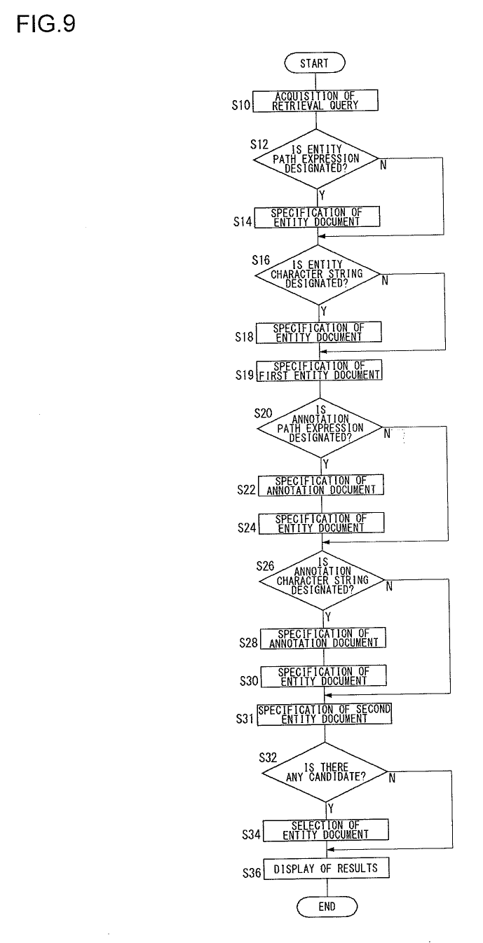

The entity document selection unit 132 selects an entity document that meets the retrieval condition of a retrieval query from the first entity document and the second entity document, and the display unit 114 screen displays the entity document selected by the entity document selection unit 132. The selection processing by the entity document selection unit 132 will be described in detail with reference to FIG. 9.

The registration unit 134 registers, when anew entity document is added in the entity document data base 144, various entity information of the entity document in the entity path index information 150 and the entity character string index information 160. When an entity document in the entity document data base 144 is edited or deleted, the registration unit 134 also updates the contents of the entity path index information 150 and the entity character string index information 160. In adding a new annotation document or editing and deleting an annotation document, the registration unit 134 updates the contents of the annotation path index information 170 and the annotation character string index information 180.

FIG. 9 is a flow chart illustrating a process of retrieval processing based on a retrieval query. In the same drawing, the processings from S12 to S19 correspond to the entity retrieval processing, and those of S20 to S31 correspond to the annotation retrieval processing. The input unit 112 at first receives an input of a retrieval query from a user (S10). The retrieval query is denoted in the format of “entity data for retrieval, logical expression A, annotation data for retrieval”, that is, “(entity path expression, logical expression B, entity character string), logical expression A, (annotation path expression, logical expression C, construed character string)”. The logical expressions B and C indicate either “AND” or “OR”. The logical expression A indicates any one of “AND”, “OR”, and “inclusion (INCL)”. Herein, a description will be at first made on the premise that the retrieval query: “(/report AND Hanae”) AND (/metadata/annotation/product title AND release date)” is inputted.

The first entity document specification unit 126 extracts entity data for retrieval from an retrieval query. In the case of the above example, “/report AND Hanae” is extracted. When an entity path expression is included in the entity data for retrieval (S12/Y), the first entity document specification unit 126 specifies an entity document including the designated entity path expression (S14). In the case of the above example, because the entity path expression “/report” is included in the entity document (ID: 1), the entity document (ID: 2), and the entity document (ID: 6), these three entity documents are specified. When an entity path expression is not included (S12/N), the processing of S14 is skipped.

When an entity character string is included in the entity data for retrieval (S16/Y), the first entity document specification unit 126 specifies an entity document including the designated entity character string (S18). In the case of the above example, because the entity character string “Hanae” is included in the entity document (ID: 2), the entity document (ID: 6), and the entity document (ID: 8), the entity document (ID: 2), the entity document (ID: 6), and the entity document (ID: 8) are specified. When the entity character string is not included (S16/N), the processing of S18 is skipped.

The first entity document specification 126 specifies a first entity document based on the above processing results (S19). When entity data for retrieval is not included or when an entity document that meets the entity data for retrieval does not exist, a first entity document is not specified. In the case of the above example, because the entity document (ID: 2) and the entity document (ID: 6) meet the retrieval condition indicated by the entity data for retrieval “/report AND Hanae”, these two entity documents are specified as first entity documents. When the entity data for retrieval is not “/report AND Hanae” but “/report OR Hanae”, the entity document (ID: 1), the entity document (ID: 6), and the entity document (ID: 8) are specified as first entity documents.

The annotation document specification unit 128 extracts annotation data for retrieval from a retrieval query. In the case of the above example, “/metadata/annotation/product title AND release date” is extracted. When an annotation path expression is included in the annotation data for retrieval (S20/Y), the annotation document specification unit 128 specifies an annotation document including the designated annotation path expression (S22), and the second entity document specification unit 130 specifies an entity document corresponding to the annotation document (S24). In the case of the above example, because the annotation path expression “/metadata/annotation/product title” is included in the annotation document (ID: 1) and the annotation document (ID: 2), both the entity document (ID: 1) and the entity document (ID: 2) are specified. When an annotation path expression is not included (S20/N), the processing of S22 and S24 are skipped.

When an annotation character string is included in the annotation data for retrieval (S26/Y), the annotation document specification unit 128 specifies an annotation document including the designated annotation character string (S28), and the second entity document specification unit 130 specifies an entity document corresponding to the annotation document (S30). In the above example, because the annotation character string “release date” is included in the annotation document (ID: 2) and the annotation document (ID: 4), the entity document (ID: 2) and the entity document (ID: 4) are specified. When an annotation character string is not included (S26/N), the processing of S28 and S 30 are skipped.

The second entity document specification unit 130 specifies a second entity document based on the above processing results (S31). When annotation data for retrieval is not included or when an annotation document that meets the annotation data for retrieval does not exist, a second entity document is not specified. In the case of the above example, because only the entity document (ID: 2) meets the retrieval condition indicated by the annotation data for retrieval “/metadata/annotation/product title AND release date”, only the entity document (ID: 2) is specified as a second entity document. When the annotation data for retrieval is not “/metadata/annotation/product title AND release date” but “/metadata/annotation/product title OR release date”, the entity document (ID: 1), the entity document (ID: 2), and the entity document (ID: 4) are specified as second entity documents.

When at least either of a first entity document or a second entity document is specified, in other words, when candidates for the entity document that meet a retrieval query are present (S32/Y), the entity document selection unit 132 selects an entity document that meets the retrieval query from the candidates (S34). In the case of the above example, because the retrieval query is “entity data for retrieval AND annotation data for retrieval”, the entity document (ID: 2) is selected, which is included in both of the entity document (ID: 2) and the entity document (ID: 6) that are specified as first entity documents, and the entity document (ID: 2) that is specified as a second entity document. When the annotation data for retrieval is not “entity data for retrieval AND annotation data for retrieval” but “entity data for retrieval OR annotation data for retrieval”, both the entity document (ID: 2) and the entity document (ID: 6) are selected. When a first entity document is specified and a second entity document is not specified, the entity document selection unit 132 selects the entity document specified as a first entity document, as it is. When a second entity document is specified and a first entity document is not specified, the entity document specified as a second entity document is selected as it is. When both a first entity document and a second entity document are not specified (S32/N), the processing of S34 is skipped. Finally, the display unit 114 screen displays the document ID and the title of the selected entity document (S36). When an entity document is not selected, that is, when an entity document that meets a retrieval query does not exist, the display unit 114 communicates the result to a user on the screen.

In the above processing, the entity retrieval processing and the annotation retrieval processing are separately carried out, and the entity document selection unit 132 finally selects an entity document in accordance with the results of each processing. The document retrieval apparatus 100 may also carry out an entity document retrieval based on an annotation range, without being limited to the above processing method. For example, a retrieval need: “an entity document including the character string “Hanae” in the entity information annotated by the tag <product title> in an annotation document, is desired to be retrieved”, is envisaged. In the case, it is needed that the entity character string “Hanae” is present in “the entity information annotated by the tag <product title>”, and the entity retrieval processing based on the entity character string “Hanae” is dependent on the processing result of the annotation retrieval processing based on the tag <product title>. A retrieval query commanding a retrieval to be carried out based on entity data for retrieval on the premise of a retrieval condition based on annotation data for retrieval, is described in the format of “entity data for retrieval INCL annotation data for retrieval”. In the case of the above example, the retrieval query is “(“Hanae”) INCL (//product title)”. “//product title” means all path expressions in which end portions the tag <product title> is present. “//” has the same meaning as an ellipsis in the XPath (XML Path Language). A description will be made taking the retrieval query as an example.

The first entity document specification unit 126 at first carries out entity retrieval processing taking the entity character string “Hanae” as a target, and specifies the entity document (ID: 2), the entity document (ID: 6), and the entity document (ID: 8), as first entity documents. Subsequently, the annotation document specification unit 128 specifies the annotation document (ID: 1) and the annotation document (ID: 2) as annotation documents including “product title” in the annotation path expressions, and the second entity document specification unit 130 specifies the entity document (ID: 1) and the entity document (ID: 2) as second entity documents.

The entity document selection unit 132 specifies the annotation range of the tag <product title> with reference to the annotation document (ID: 1) and the annotation document (ID: 2). According to the annotation path index information 170, “/metadata/annotation/product title” in the annotation document (ID: 1) is to annotate the document position=(3,5)in the entity document (ID: 1). According to the entity character string index information 160, the entity character string “Hanae” is not present in the entity document (ID: 1). Therefore, the entity document (ID: 1) is excluded from a candidate.

On the other hand, “metadata/annotation/product title” in the annotation document (ID: 2) is to annotate the document position=(6,8) in the entity document (ID: 2). According to the entity character string index information 160, the entity character string “Hanae” is present at the document position=7 in the entity document (ID: 2). That is, the entity character string “Hanae” in the entity document (ID: 2) falls within the range designated by annotation elements of “/metadata/annotation product title” in the annotation document (ID: 2). By the processing stated above, the entity document selection unit 132 selects the entity document (ID: 2) as an entity document that meets the above retrieval query.

Besides the above need, another needs can also be envisaged that: “an entity document including the character string “release date” in annotation information that annotates the tag <time> in the entity document, is desired to be retrieved”; or “an entity document of which entity path expression “/report/content/security” is annotated by the annotation path expression “/metadata/annotation”, is desired to be retrieved”. In such cases, a desired entity document can also be specified by carrying out either of the annotation retrieval processing or the entity retrieval processing dependently on the result of the other processing of the two.

As stated above, according to the document retrieval apparatus 100 illustrated in the present embodiment, data retrieval based on a retrieval query can be carried out from both sides of entity information and annotation information. Because an entity document and an annotation document are associated with each other as separate document files, the contents of the entity document are not necessary to be changed by providing annotation information. Moreover, annotation information inputted by a plurality of users can be managed in an integrated fashion with the use of annotation documents. Therefore, the document retrieval apparatus 100 is designed such that a plurality of users can set annotation information freely, while the identity of entity information is guaranteed. Contents of a document per se or how a document is read are often simply shown by additional information attached to the document such as memos, cautionary notes, and remarks. According to the document retrieval apparatus 100 in the present embodiment, a document can be retrieved from not only entity information that is retrieved directly, but also annotation information attached to the entity information. Therefore, the apparatus has an advantage that convenience of users in retrieving documents is improved.

Entity path expressions and entity character strings are registered in the entity path index information 150 and the entity character string index information 160. Hence, the entity retrieval unit 122 can specify a first entity document by the entity path index information 160 and the entity character string index information 160, without access to the entity document data base 144 to deploy the contents of the entity document and the path information in the memory. Similarly, annotation path expressions and annotation character strings are registered in the annotation path index information 170 and the annotation character string index information 180. Hence, the annotation retrieval unit 124 can also specify an annotation document, furthermore a second entity document by referring to each index information, without access to the annotation document data base 146 to deploy the contents of the annotation document and path information in the memory. As stated above, the document retrieval apparatus 100 illustrated in the present embodiment can retrieve a position of desired data at a high speed and with a light load on a computer.

Described above is the explanation of the present invention based on an embodiment. The embodiment is intended to be illustrative only and it will be obvious to those skilled in the art that various modifications to constituting elements and processes could be developed and that such modifications are also within the scope of the present invention.

In the present embodiment, the description has been made with an XML document targeted; however, the document retrieval apparatus 100 is applicable to document files described in any one of XHTML, HTML, SGML and so forth in which a position of data can be specified by a path expression based on a hierarchical structure of tags.

The “entity index information” described in the claims corresponds to both or either of the entity path index information 150 and/or the entity character string index information 160 in the present embodiment. The “annotation index information” described in the claims corresponds to both or either of the annotation path index information 170 and/or the annotation character string index information 180 in the present embodiment. The “certain selection condition” described in the claims corresponds to the “logical expression A” of the retrieval query in the present embodiment. It will be obvious to those skilled in the art that the function to be achieved by each constituent requirement described in the claims may be achieved by each functional block shown in the exemplary embodiment or by a combination of the functional blocks.

### INDUSTRIAL APPLICABILITY

According to the present invention, a desired document file can be retrieved efficiently from a plurality of document files with the use of annotation information.

1. A document retrieval apparatus for retrieving a desired structured document file from a group of structured document files in which a data position is specified by a path expression based on a hierarchical structure of tags, the document retrieval apparatus comprising:
an entity index holder that holds entity index information in which certain data and an entity document including the data are associated, with respect to a group of entity documents that are structured document files including entity information;
an annotation index holder that holds annotation index information in which certain data and an annotation document including the data are associated, with respect to a group of annotation documents that are structured document files associated with the entity documents and that include annotation information corresponding to the entity information;
a retrieval query input unit that receives an input of a retrieval query including entity data for retrieval that targets an entity document, and annotation data for retrieval that targets an annotation document;
a first entity document specification unit that specifies an entity document including the entity data for retrieval, with reference to the entity index information;
an annotation document specification unit that specifies an annotation document including the annotation data for retrieval, with reference to the annotation index information;
a second entity document specification unit that specifies an entity document associated with the specified annotation document; and
an entity document selection unit that selects an entity document that meets a certain selection condition with respect to the retrieval query, from the entity document specified by the first entity document specification unit and the entity document specified by the second entity document specification unit.

2. The document retrieval apparatus according to claim 1, wherein the entity document selection unit selects an entity document that is specified by the first entity document specification unit and the second entity document specification unit.

3. The document retrieval apparatus according to claim 1, wherein a tag path expression and an entity document in which the tag path expression is present are associated in the entity index information, and wherein, when a tag path expression is included in the entity data for retrieval, the first entity document specification unit specifies an entity document in which the tag path expression is present, with reference to the entity index information.

4. The document retrieval apparatus according to claim 1, wherein a tag path expression and an annotation document in which the tag path expression is present are associated in the annotation index information, and wherein, when a tag path expression is included in the annotation data for retrieval, the annotation document specification unit specifies an annotation document in which the tag path expression is present, with reference to the annotation index information.

5. The document retrieval apparatus according to claim 1, wherein a certain character string and an entity document including the character string are associated in the entity index information, and wherein, when a character string to be retrieved is included in the entity data for retrieval, the first entity document specification unit specifies an entity document including the character string to be retrieved, with reference to the entity index information.

6. The document retrieval apparatus according to claim 1, wherein a certain character string and an annotation document including the character string are associated in the annotation index information, and wherein, when a character string to be retrieved is included in the annotation data for retrieval, the annotation document specification unit specifies an annotation document including the character string to be retrieved, with reference to the annotation index information.

7. The document retrieval apparatus according to claim 1, wherein certain data and a position of entity information to be annotated by the data are further associated in the annotation index information, and wherein the annotation document specification unit specifies not only an annotation document including the annotation data for retrieval but also a position of the entity information to be annotated by the annotation data for retrieval, with reference to the annotation index information, and wherein the entity document selection unit selects an entity document including the entity data for retrieval as a selection target in the entity information to be annotated by the annotation data for retrieval, among the entity documents specified by the first entity document specification unit.

8. A method for retrieving a desired structured document file from a group of structured document files in which a data position is specified by a path expression based on a hierarchical structure of tags, the method comprising:
acquiring entity index information in which certain data and an entity document including the data are associated, with respect to a group of entity documents that are structured document files including entity information;
acquiring annotation index information in which certain data and an annotation document including the data are associated, with respect to a group of annotation documents that are structured document files associated with the entity documents and that include annotation information corresponding to the entity information;
receiving an input of a retrieval query including entity data for retrieval that targets an entity document and annotation data for retrieval that targets an annotation document;
specifying an entity document including the entity data for retrieval with reference to the entity index information;
specifying an annotation document including the annotation data for retrieval with reference to the annotation index information;
specifying an entity document associated with the specified annotation document; and
selecting an entity document that meets a certain selection condition with respect to the retrieval query, from the entity document specified by the entity data for retrieval and the entity document specified by the annotation data for retrieval.

9. A document retrieval computer program product for retrieving a desired structured document file from a group of structured document files in which a data position is specified by a path expression based on a hierarchical structure of tags, the document retrieval computer program product comprising:
a module that holds entity index information in which certain data and an entity document including the data are associated, with respect to a group of entity documents that are structured document files including entity information;
a module that holds annotation index information in which certain data and an annotation document including the data are associated, with respect to a group of annotation documents that are structured document files associated with the entity documents and that include annotation information corresponding to the entity information;
a module that receives an input of a retrieval query including entity data for retrieval that targets an entity document and annotation data for retrieval that targets an annotation document;
a module that specifies an entity document including the entity data for retrieval, with reference to the entity index information;
a module that specifies an annotation document including the annotation data for retrieval, with reference to the annotation index information;
a module that specifies an entity document associated with the specified annotation document; and
a module that selects an entity document that meets a certain selection condition with respect to the retrieval query from the entity document specified by the entity data for retrieval and the entity document specified by the annotation data for retrieval.
